(19) United States
(12) Patent Application Publication
(10) Pub. No.: US 2026/0104091 A1
(43) Pub. Date: Apr. 16, 2026

(54) Sealing Profile

(71) Applicant: Binder GmbH, Tuttlingen (DE)

(72) Inventors: Ahmet ARABUL, Tuttlingen (DE); Alexander PEPLER, Donaueschingen (DE)

(73) Assignee: Binder GmbH, Tuttlingen (DE)

(21) Appl. No.: 19/342,793

(22) Filed: Sep. 29, 2025

(30) Foreign Application Priority Data
Oct. 14, 2024 (DE) 1020241296887

(51) Int. Cl. F16J 15/02; F25D 23/08

(52) U.S. Cl. CPC F16J 15/025; F16J 15/027; F25D 23/087

(57) ABSTRACT

A sealing profile for sealing a gap between a door and a door stop comprises a hollow profile having a wall with a wall inner side and a wall outer side, where the wall inner side defines a hollow volume. The hollow profile includes a profile foot, a first sealing lip having a first sealing lip first end and a first sealing lip second end, and a second sealing lip having a second sealing lip first end and a second sealing lip second end. The profile foot is substantially U-shaped and comprises a first profile foot shank, a second profile foot shank that is longer than the first profile foot shank, and a profile foot bottom.

### CROSS REFERENCE TO RELATED APPLICATIONS

This application claims priority to German Patent Application No. 10 2024 129 691.7, filed Oct. 14, 2024, the entirety of which is incorporated by reference.

### FIELD OF APPLICATION

The application relates to a sealing profile for sealing a gap between a door and a door stop.

### BACKGROUND

Climate chambers in various physical forms are known in prior art and are employed in scientific laboratories or industrial operations for the purpose of simulating biological, chemical and/or physical environmental conditions, such as for example temperature, atmospheric pressure and/or humidity. A climate chamber comprises a housing with an interior volume within the housing, wherein in the interior volume the biological, chemical, and/or physical environmental conditions are simulated.

Known are climate chambers with a housing with at least one base body comprising a door and an interior volume closable by means of the at least one door. Therein in a closed position the door is intended to fit as tightly as feasible against a door stop disposed on the base body. The door stop can herein be disposed on a stationary portion of the base body, for example a door frame, as well as also on a further door in the event the climate chamber comprises a double wing door.

The doors of the climate chambers not only enable physical access to the interior volume but must also comprise thermal insulation as a wall in order to thermally decouple the interior volume from its surroundings. In the interior of the climate chamber a desired climate can be set in particular by regulating the temperature and/or the humidity. Climate chambers can typically be set to temperatures between −10° C. and 100° C., however there are likewise climate chambers for high temperature ranges in which temperatures of up 350° C. can be set over long periods in the interior volume or also deep-freeze devices in which temperatures down to −85° C. can be set for long periods of time. Herein the doors must have sufficient insulation, on the one hand, and, in addition, must furthermore seal tightly the gap between the door and door stop such that, aside from heat exchange with the surroundings, mass exchange can be prevented as well. It is known to provide for this purpose a sealing on the door or on the door stop.

DE 20 2008 000 970 U1 for example discloses an elastic sealing profile with a profile foot for retaining the sealing profile in a groove of a frame rabbet of a door stop as well as a profile head on which a sealing lip is disposed which is in contact on a surface of the door when the door is closed.

Further sealing profiles which when the door is closed establish a sealing effect on a single surface are disclosed in EP 0 436 810 A1, DE 87 11 518 U1, and DE 85 28 149 U1.

However, it has been found that the disadvantage of the sealing profiles known in prior art is that sealing with a sealing lip on a surface is not adequate for many applications, in particular in climate chambers with extreme climate conditions.

The present disclosure therefore addresses the problem of providing a sealing profile which enables improved sealing effects.

### SUMMARY

This problem is resolved through a sealing profile with the characteristics disclosed herein.

Advantageous embodiments and further developments of the present disclosure are described herein.

The sealing profile described herein for sealing a gap between a door and a door stop is developed as a hollow profile with a wall which comprises an inner side and an outer side and with the inner side encompasses a hollow volume, wherein the hollow profile comprises a profile foot as well as a first sealing lip, comprising a first end and a second end, and a second sealing lip, comprising a first end and a second end, wherein the profile foot is developed approximately U-shaped with a first profile foot shank, comprising a first end and a second end, a second profile foot shank, comprising a first end and a second end, and a profile foot bottom, wherein the second profile foot shank is longer than the first profile foot shank, wherein the first sealing lip is disposed with its first end across a first hinged joint on the first end of the first profile foot shank, wherein the second sealing lip is disposed with its first end across a second hinged joint on the first end of the second profile foot shank, wherein the second end of the first sealing lip and the second end of the second sealing lip are connected with one another across a third hinged joint, and wherein the first sealing lip and the second sealing lip form at the third hinged joint a first angle which is greater than 180°. By providing two sealing lips, which are connected with one another across a hinged joint, that form a first angle of more than 180°, leads thereto that the ability for the sealing profile can bend inwardly when the door swings in onto the door stop at the third hinged joint between the two sealing lips, and consequently the two sealing lips are brought into contact at two surfaces at an angle forming a seal which, in comparison to a single sealing lip which can only be brought into contact on one surface to form a seal, brings about improved sealing effects. In the unloaded state of the sealing profile the first angle is preferably between 230° and 250° and is for example approximately 240°, while when installed with the door closed, consequently under load, the first angle is preferably approximately 270°.

The first hinged joint, the second hinged joint, and the third hinged joint are preferably developed through a material attenuation in the wall of the hollow profile. Hinged joints developed thusly can be fabricated simply and cost-effectively.

According to a preferred embodiment the third hinged joint is developed by attenuation of the material on the outside of the wall of the hollow profile. Bending the sealing profile inwardly between the two sealing lips can thereby be facilitated.

The first hinged joint is preferably developed by an attenuation of the material on the inside of the wall of the hollow profile. Swivelling the first sealing lip inwardly toward the profile foot can be facilitated through such physical form.

The second hinged joint is advantageously developed by an attenuation of the material on the inside of the wall of the hollow profile. Swivelling the second sealing lip inwardly toward the profile foot can be facilitated through such physical form.

According to a preferred embodiment the first sealing lip is developed as a planar element. Suchlike physical forms enable the largest feasible sealing surface.

The first sealing lip advantageously comprises a first sealing lip longitudinal axis and the first profile foot shank comprises a first profile foot shank longitudinal axis which, in an unloaded state of the sealing profile are disposed at a second angle between 100° and 125° with respect to one another, wherein the second angle is preferably approximately 108°. Through such physical form, tolerances between the door and the door stop in the closed position can be compensated while, nevertheless, good sealing effects can be achieved.

A preferred embodiment provides for the second sealing lip to have an L-shaped cross section with a first shank encompassing the first end of the second sealing lip and a second shank encompassing the second end of the second sealing lip, wherein the two shanks are disposed, in particular rigidly, with respect to one another at a third angle between 80° and 90°, wherein the third angle is preferably approximately 85°. Through such angular development of the second sealing lip, on the one hand also a largest feasible sealing surface between the second shank and the contact surface can be attained, wherein the application of the contact pressure can be applied through the first shank. The physical form in which the third angle between the two shanks is less than 90° promotes herein the application of the contact pressure. The rigid disposition of the two shanks of the second sealing lip, stated differently, means that precisely no hinged joint is provided whereby the contact pressure can be improved for attaining the sealing effect.

The first shank of the second sealing lip preferably comprises a first sealing lip shank longitudinal axis and the second profile foot shank comprises a second profile foot shank longitudinal axis, which in the unloaded state of the sealing profile are disposed with respect to one another at a fourth angle between 100° and 125°, wherein the fourth angle is preferably approximately 105°. Through such physical form, tolerances between the door and the door stop in the closed position can be compensated while, nevertheless, good sealing effects can be obtained.

Thereby that in a preferred physical form the second angle between the first sealing lip longitudinal axis and the first profile foot shank longitudinal axis deviates from the fourth angle between the first sealing lip shank longitudinal axis and the second profile foot shank longitudinal axis, preferably by a difference of 2° to 4°, the tolerance compensation and the sealing effect can be improved further.

On the profile foot on the outer side of the wall of the hollow profile, preferably on the first profile foot shank and/or on the second profile foot shank, at least one holding means is preferably disposed which is preferably developed as a holding lip or a holding rib. Such holding means can ensure the sealing profile against falling out of a groove on the door or the door stop, for example thereby that improved frictional closure is attained, or also thereby that the holding means engage into corresponding recesses, for example slots, and latch in.

The profile foot bottom advantageously comprises a ribbing on the outside of the wall of the hollow profile, which can enable improved ability to assemble and dissemble the sealing profile, in particular through ventilation, when emplacing the sealing profile into a groove on the door or on the door stop.

According to a preferred embodiment the sealing profile is fabricated of a synthetic material, preferably a silicone. The use of such material promotes the elastic properties and the sealing effect of the sealing profile. The sealing profile can herein be preferably produced in an extrusion process.

A sealing profile is preferably employed in a climate chamber which comprises a door, swivellable between an open and a closed position, and a doorstop, wherein the door stop comprises a first contact surface and a second contact surface, which are disposed with respect to each other at a fifth angle between 80° and 100°, wherein on the door the sealing profile is disposed and wherein in a closed state of the door the first sealing lip is at least sectionally in contact on the first contact surface, and the second sealing lip is at least sectionally in contact on the second contact surface. By sealing two contact faces disposed with respect to one another at the fifth angle a good sealing effect can be attained. The fifth angle can be approximately 90°.

### BRIEF DESCRIPTION OF THE DRAWINGS

An embodiment example will be explained in detail in conjunction with the following Figures. Therein depict

FIG. 1 a cross section of an embodiment example of a sealing profile in the unloaded state,

FIG. 2 a cross section of the sealing profile according to FIG. 1 under load,

FIG. 3 a view from the front onto an embodiment example of a climate chamber with a door in an open position on which a sealing profile according to FIG. 1 is disposed,

FIG. 4 a view from the front onto the climate chamber according to FIG. 3 with the door in a closed position,

FIG. 5 a view from above onto the climate chamber according to FIG. 4,

FIG. 6 a detail enlargement of a cross section through the climate chamber according to FIG. 5,

FIG. 7 a perspective view of the climate chamber according to FIG. 3 and

FIG. 8 a detail enlargement from FIG. 7.

### DETAILED DESCRIPTION

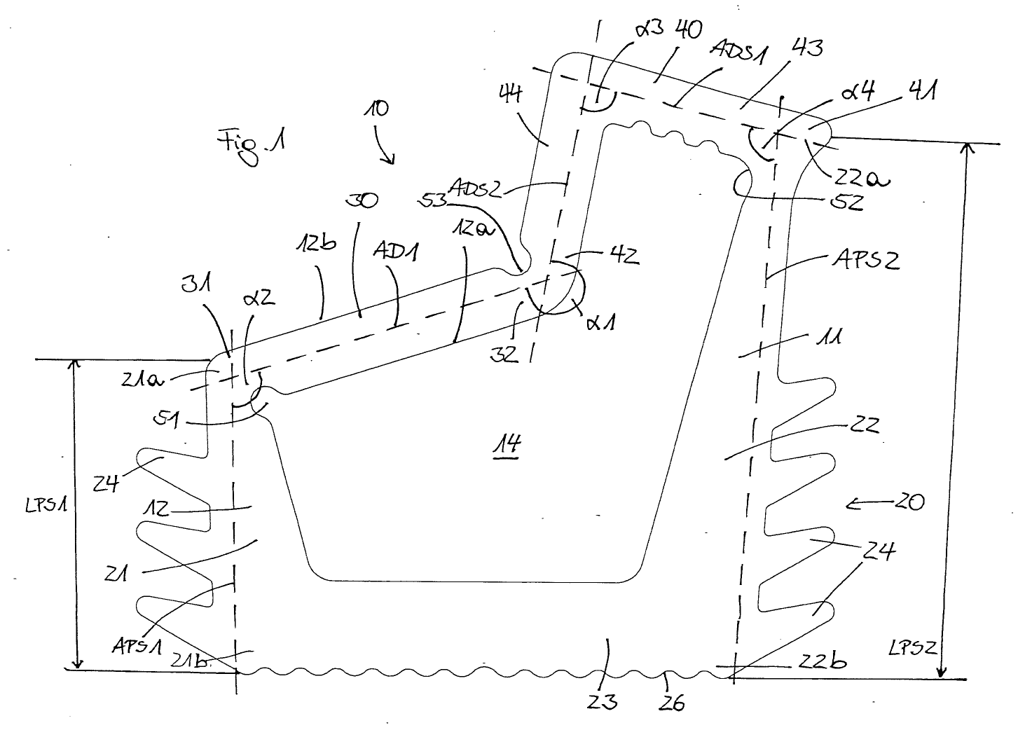

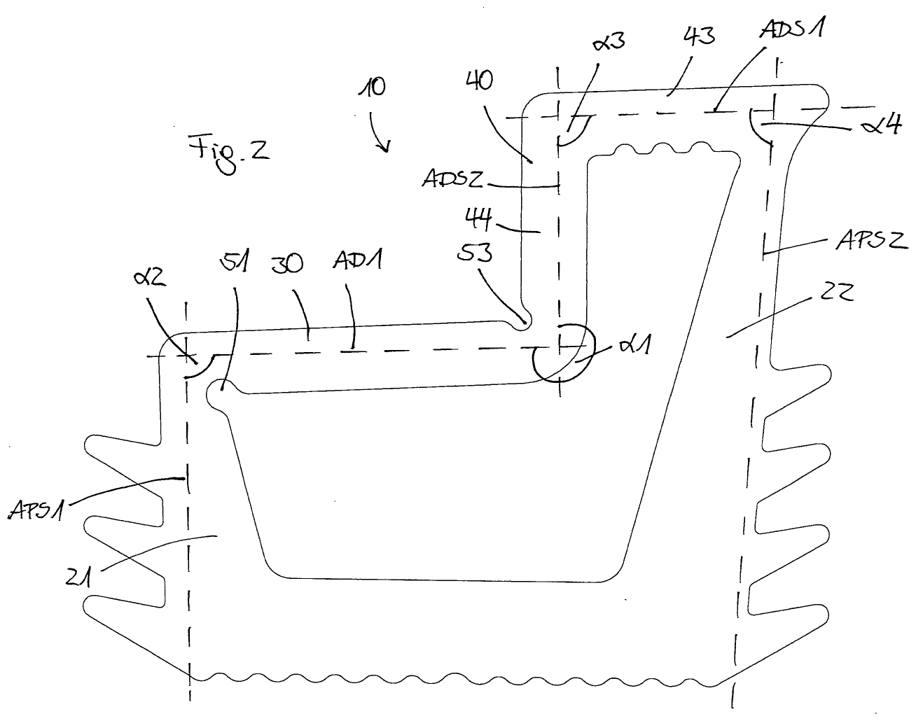

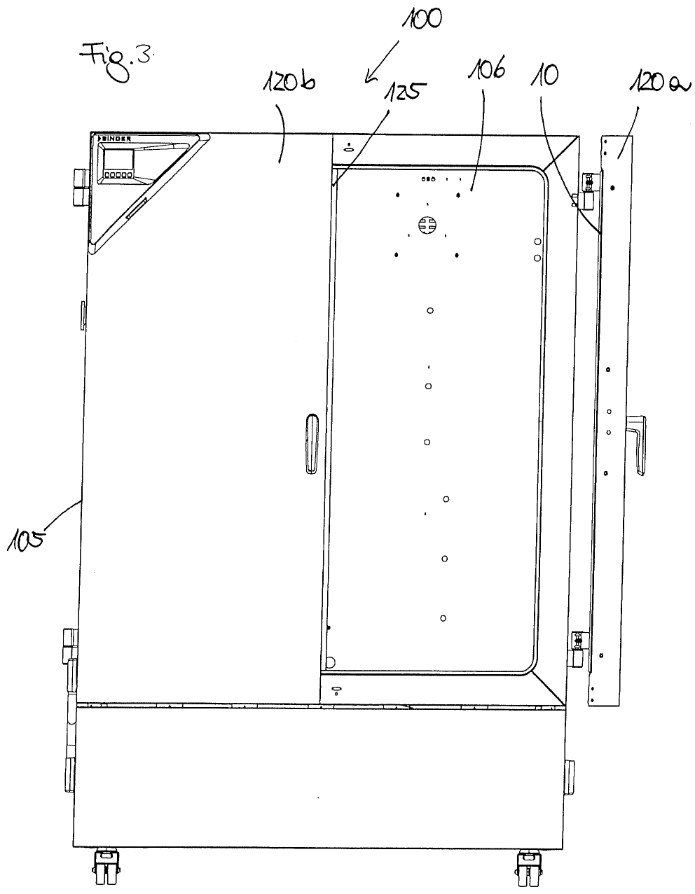

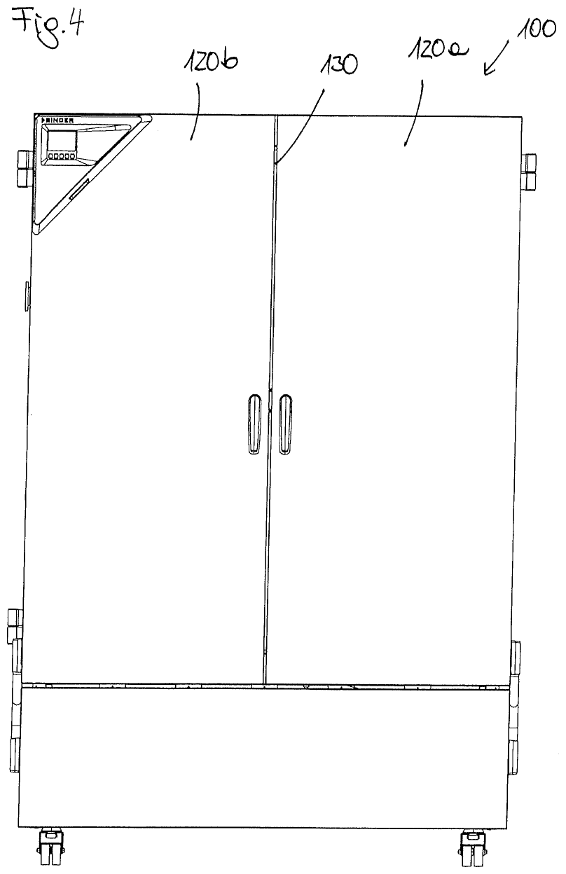

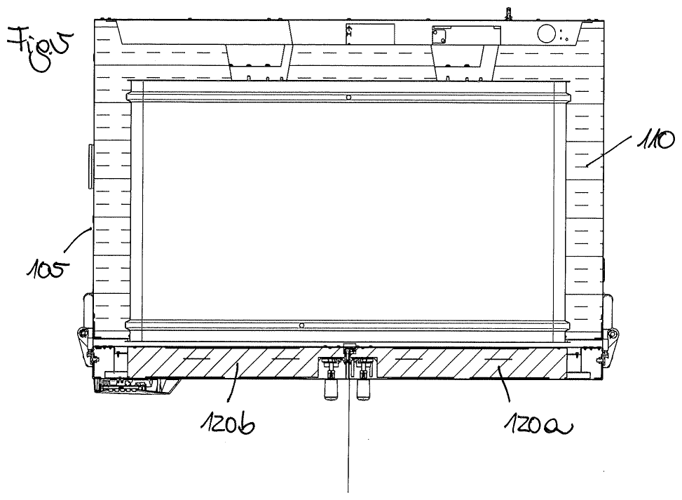

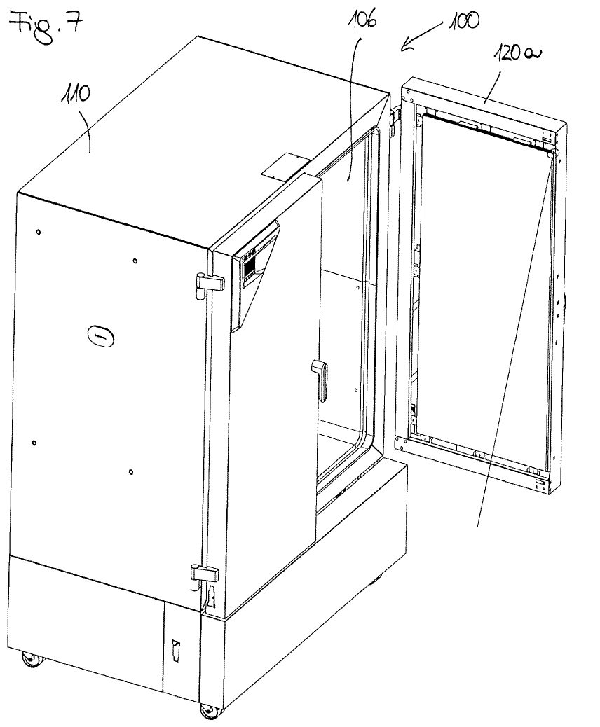

FIGS. 1 and 2 show cross sections of an embodiment example of a sealing profile 10, FIGS. 3 to 8 illustrate the installation of such sealing profile 10 into a climate chamber 100.

Same or functionally same components are identified with same reference symbols, wherein for greater clarity not all reference numbers are quoted.

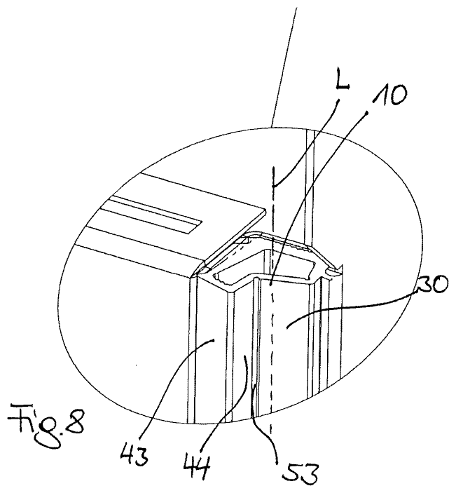

The sealing profile 10 is developed as a hollow profile 11 with a wall 12 comprising an inner side 12a and an outer side 12b. By the inner side 12a a hollow volume 14 is enclosed. The sealing profile 10 can be fabricated of a synthetic material, in particular of a silicone, and can be produced, for example, employing an extrusion process. The sealing profile 10 has a longitudinal axis L, shown in FIG. 8 that extends perpendicularly to the cross section depicted in FIG. 1.

The hollow profile 11 comprises a profile foot 20 as well as a first sealing lip 30 comprising a first end 31 and a second end 32, and a second sealing lip 40 comprising a first end 41 and a second end 42.

The profile foot 20 is developed approximately U-shaped with a first profile foot shank 21, comprising a first profile foot shank longitudinal axis APS1, a first end 21a and a second end 21b as well as a length LPS1, a second profile foot shank 22, comprising a second profile foot shank longitudinal axis APS2, a first end 22a and a second end 22b as well as a length LPS2, and a profile foot bottom 23. The first profile foot shank 21 is disposed with its first end 21a in contact on the profile foot bottom 23, while the second profile foot shank 22 is disposed with its first end 22a on the profile foot bottom 23. The first profile foot shank longitudinal axis APS1 and the second profile foot shank longitudinal axis APS2 are preferably disposed substantially perpendicularly to the profile foot bottom 23. The first profile foot shank 21 and the second profile foot shank 22 can each extend with its thickness slimming down from the profile foot bottom 23, for which the inner side 12a of wall 12 of the hollow profile 11 can be developed such that it slants toward the first profile foot shank longitudinal axis APS1 respectively the second profile foot shank longitudinal axis APS2.

The length LPS2 of the second profile foot shank 22 is greater than the length LPS1 of the first profile foot shank 21.

On the profile foot 20 on the outer side 12b of the wall 12 of the hollow profile 11, preferably on the first profile foot shank 21 and/or the second profile profile foot shank 22, can be disposed at least one holding means 24. The holding means 24 can for example be developed as a holding lip or a holding rib and preferably extend in the direction parallel to the longitudinal axis L, shown in FIG. 8 of the sealing profile 10.

The profile foot bottom 23 can comprise a ribbing 26 on the outer side 12a of the wall 12 of the hollow profile 11, which also preferably extends in the direction parallel to the longitudinal axis L, only in FIG. 8 of the sealing profile 10.

The first sealing lip 30 is disposed with its first end 31 across a first hinged joint 51 on the first end 21a of the first profile foot shank 21, while the second sealing lip 40 with its first end 41 is disposed across a second hinged joint 52 on the first end 22a of the second profile foot shank 22. The second end 32 of the first sealing lip 30 and the second end 42 of the second sealing lip 40 are connected with one another across a third hinged joint 53, wherein the first sealing lip 30 and the second sealing lip 40 form at the third hinged joint 53 a first angle α1 which is greater than 180°. In particular the first angle α1 in the unloaded state of the sealing profile 10 is between 230° and 250° and is preferably approximately 240° (cf. FIG. 1). When the sealing profile 10, as will be described in the following in even greater detail, has been installed in the climate chamber 100 and is under load through the closing of a door 120a, the sealing profile 10 is bent at the third hinged joint 53 until the first angle α1 is preferably approximately 270° (cf. FIG. 2).

The first hinged joint 51, the second hinged joint 52 and the third hinged joint 53 can be developed by an attenuation of the material in the wall 12 of the hollow profile 11. In this manner the hinged joints 51, 52, 53 can be developed as a type of living hinged joint. The third hinged joint 53 is developed in particular by attenuation of the outer side 12b of the wall 12 of the hollow profile 11, while the first hinged joint 51 and the second hinged joint 52 are developed in particular by an attenuation of the material on the inside 12a of the wall 12 of the hollow profile 11. The material attenuation is thus developed in particular on that side of the wall 12 of the hollow profile 11 on which the particular hinged joint 51, 52, 53 folds together.

The first sealing lip 30 can be developed as a planar element with a first sealing lip longitudinal axis AD1. The first sealing lip longitudinal axis AD1 and the first profile foot shank longitudinal axis APS1 in an unloaded state of the sealing profile 10 are disposed at a second angle α2 with respect to one another, which is between 100° and 125° and is preferably approximately 108° (cf. FIG. 1). When the sealing profile 10 is under load, the angle α2 decreases up to approximately 90° (cf. FIG. 2).

The second sealing lip 40 can comprise an L-shaped cross section with a first shank 43 encompassing the first end 41 of the second sealing lip 40 and a second shank 44 encompassing the second end 42 of the second sealing lip 40. The first shank 43 herein comprises a first sealing lip shank longitudinal axis ADS1 and the second shank 44 comprises a second sealing lip shank longitudinal axis ADS2. The two shanks 43, 44, in particular the first sealing lip shank longitudinal axis ADS1 and the second sealing lip shank longitudinal axis ADS2 are disposed at a third angle α3 with respect to one another, which lies between 80° and 90° and is preferably approximately 85°. Between the first shank 43 and the second shank 44 there is in particular no hinged joint disposed which means that the first shank 43 and the second shank 44, within the frame of the elasticity of the material utilized for the sealing profile 10, are in particular disposed rigidly with respect to one another. In the embodiment of the second sealing lip 40 as an L-shaped element, the second shank 44, in particular the second sealing lip shank longitudinal axis ADS2, forms with the first sealing lip 30, in particular with the first sealing lip longitudinal axis AD1, the first angle α1.

The first sealing lip shank longitudinal axis ADS1 of the first shank 43 and the second profile foot shank longitudinal axis APS2 of the second profile foot shank 22 in the unloaded state of the sealing profile 10 are disposed at a fourth angle α4 which is preferably between 100° and 125° and is, for example, approximately 105° (cf. FIG. 1). When the sealing profile 10 is under load, the angle α4 decreases to approximately 90° (cf. FIG. 2).

The climate chamber 100 depicted in FIGS. 3 to 8 comprises a housing 105 with a base body 110 and at least one door 120a, in the present case two doors 120a, 120b, each swivellable between an open and a closed position, wherein the housing 105 encloses an interior volume 106. The climate chamber 100 encompasses further a door stop 125 for the door 120a. If precisely only one door 120a is provided, the door stop 125 can be completely disposed on the base body 110. If, as depicted in the present embodiment example, the climate chamber 100 comprises two doors 120a, 120b, the door stop 125 for the door 120a, at least for the free front edge of the door 120a, can be disposed on the other door 120b. The door stop 125 for the upper edge and lower edge of door 120a can be disposed on the base body 110.

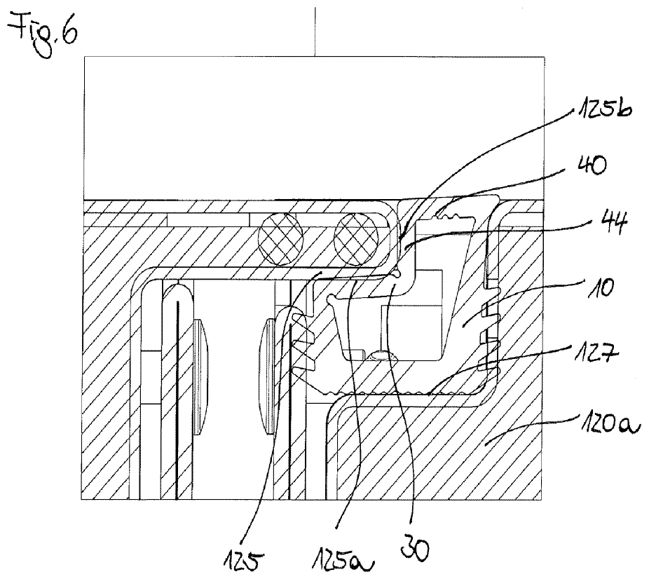

The door stop 125 comprises a first contact surface 125a and a second contact surface 125b which are disposed at a fifth angle α5 with respect to one another, wherein the fifth angle α5 lies between 80° and 100° and is preferably approximately 90°. The sealing profile 10 is developed for sealing a gap 130 between the door 120a and the door stop 125. For this purpose the sealing profile 10 can be disposed on the door 120a, in particular in a groove 127, which can, for example, be disposed on a side edge of door 120a. The sealing profile 10 for this purpose is set with the profile foot 20 into the groove 127 (cf. FIG. 6). The holding means 24 can herein ensure sufficient purchase. The deformation of the holding means 24 is herein not shown in FIG. 6.

During the closing of door 120a the door stop 125 swings into the region between the first sealing lip 30 and the second shank 44 of the second sealing lip 40 (cf. FIG. 6). In the closed state of door 120a the sealing profile 10 is placed under load and is deformed in particular such that the first sealing lip 30, at least sectionally, is in contact on the first contact surface 125a and the second sealing lip 40, at least sectionally, is in contact on the second contact surface 125b, in particular, at least sectionally with the second shank 44 of the second sealing lip 40.

Through the sealing profile 10 with two sealing lips 30, 40 which are disposed at an angle with respect to one another and under load can swivel about the third hinged joint 53 with respect to one another, sealing on two contact surfaces 125a, 125b, also disposed at an angle with respect to one another, is enabled whereby an improved sealing effect can be achieved.

### LIST OF REFERENCE SYMBOLS

10 Sealing profile
11 Hollow profile
12 Wall
12a Inner side
12b Outer side
14 Hollow volume
20 Profile foot
21 First profile foot shank
21a First end
21b Second end
22 Second profile foot shank
22a First end
22b Second end
23 Profile foot bottom
24 Holding means
26 Ribbing
30 First sealing lip
31 First end
32 Second end
40 Second sealing lip
41 First end
42 Second end
43 First shank
44 Second shank
51 First hinged joint
52 Second hinged joint
53 Third hinged joint
100 Climate chamber
105 Housing
106 Interior volume
110 Base body
120a Door
120b Door
125a First contact surface
125b Second contact surface
127 Groove
130 Gap
α1 First angle
α2 Second angle
α3 Third angle
α4 Fourth angle
α5 Fifth angle
L Longitudinal axis L, shown only in FIG. 8
AD1 First sealing lip longitudinal axis
ADS1 First sealing lip shank longitudinal axis
ADS2 Second sealing lip shank longitudinal axis
APS1 First profile foot shank longitudinal axis
APS2 Second profile foot shank longitudinal axis
LPS1 Length of the first profile foot shank
LPS2 Length of the second profile foot shank

1. A sealing profile for sealing a gap between a door and a door stop, comprising:
a hollow profile comprising:
a wall with a wall inner side and a wall outer side, the wall inner side defining a hollow volume;
a profile foot;
a first sealing lip having a first sealing lip first end and a first sealing lip second end; and
a second sealing lip having a second sealing lip first end and a second sealing lip second end;
wherein the profile foot is substantially U-shaped and comprises:
a first profile foot shank having a first profile foot shank first end and a first profile foot shank second end,
a second profile foot shank having a second profile foot shank first end and a second profile foot shank second end, the second profile foot shank being longer than the first profile foot shank, and
a profile foot bottom;
wherein the first sealing lip is connected at the first sealing lip first end to the first profile foot shank first end via a first hinged joint;
wherein the second sealing lip is connected at the second sealing lip first end to the second profile foot shank first end via a second hinged joint;
wherein the first sealing lip second end and the second sealing lip second end are connected to one another via a third hinged joint; and
wherein the first sealing lip and the second sealing lip form a first angle at the third hinged joint that is greater than 180°.

2. The sealing profile of claim 1, wherein the first angle in an unloaded state of the sealing profile is between 230° and 250°.

3. The sealing profile of claim 2, wherein the first angle is approximately 240°.

4. The sealing profile of claim 1, wherein the first hinged joint, the second hinged joint, and the third hinged joint are each formed by a material thinning in the wall of the hollow profile.

5. The sealing profile of claim 1, wherein the third hinged joint is formed by a material thinning on the wall outer side of the wall of the hollow profile.

6. The sealing profile of claim 1, wherein the first hinged joint is formed by a material thinning on the wall inner side of the wall of the hollow profile.

7. The sealing profile of claim 1, wherein the second hinged joint is formed by a material thinning on the wall inner side of the wall of the hollow profile.

8. The sealing profile of claim 1, wherein the first sealing lip comprises a planar element.

9. The sealing profile of claim 1, wherein:
the first sealing lip has a first sealing lip longitudinal axis;
the first profile foot shank has a first profile foot shank longitudinal axis; and
in an unloaded state of the sealing profile, the first sealing lip longitudinal axis and the first profile foot shank longitudinal axis are disposed at a second angle between 100° and 125° relative to one another.

10. The sealing profile of claim 9, wherein the second angle is approximately 108°.

11. The sealing profile of claim 1, wherein the second sealing lip has an L-shaped cross section comprising:
a first shank that includes the second sealing lip first end; and
a second shank that includes the second sealing lip second end;
wherein the first shank and the second shank are disposed at a third angle between 80° and 90° relative to one another.

12. The sealing profile of claim 11, wherein the third angle is approximately 85°.

13. The sealing profile of claim 11, wherein:
the first shank of the second sealing lip has a first sealing lip shank longitudinal axis;
the second profile foot shank has a second profile foot shank longitudinal axis; and
in the unloaded state of the sealing profile, the first sealing lip shank longitudinal axis and the second profile foot shank longitudinal axis are disposed at a fourth angle between 100° and 125° relative to one another.

14. The sealing profile of claim 13, wherein the fourth angle is approximately 105°.

15. The sealing profile of claim 1, further comprising at least one retention element disposed on the profile foot on the wall outer side of the wall of the hollow profile.

16. The sealing profile of claim 15, wherein a retention element is disposed on at least one of the first profile foot shank and the second profile foot shank.

17. The sealing profile of claim 15, wherein the retention element comprises a retention lip or a retention rib.

18. The sealing profile of claim 1, wherein the profile foot bottom comprises ribbing on the wall outer side of the wall of the hollow profile.

19. The sealing profile of claim 1, wherein the sealing profile is made of a synthetic material.

20. A climate chamber comprising:
a housing defining an interior volume for simulating environmental conditions;
a door pivotably mounted to the housing and movable between an open position and a closed position; and
a door stop positioned to engage the door when the door is in the closed position, the door stop comprising a first contact surface and a second contact surface disposed at an angle between 80° and 100° relative to one another;
a sealing profile disposed on the door for sealing a gap between the door and the door stop, the sealing profile comprising;
a hollow profile comprising:
a wall with a wall inner side and a wall outer side, the wall inner side defining a hollow volume;
a profile foot;
a first sealing lip having a first sealing lip first end and a first sealing lip second end; and
a second sealing lip having a second sealing lip first end and a second sealing lip second end;
wherein the profile foot is substantially U-shaped and comprises:
a first profile foot shank having a first profile foot shank first end and a first profile foot shank second end,
a second profile foot shank having a second profile foot shank first end and a second profile foot shank second end, the second profile foot shank being longer than the first profile foot shank, and
a profile foot bottom;
wherein the first sealing lip is connected at the first sealing lip first end to the first profile foot shank first end via a first hinged joint;
wherein the second sealing lip is connected at the second sealing lip first end to the second profile foot shank first end via a second hinged joint;
wherein the first sealing lip second end and the second sealing lip second end are connected to one another via a third hinged joint; and
wherein the first sealing lip and the second sealing lip form a first angle at the third hinged joint that is greater than 180°.
